(19) United States
(12) Patent Application Publication
(10) Pub. No.: US 2015/0371342 A1
(43) Pub. Date: Dec. 24, 2015

(54) SYSTEM, METHOD AND DEVICE FOR ESTABLISHING CONNECTIONS BETWEEN ANIMALS AND THEIR GUARDIANS

(71) Applicants: William FULLER, Bluffton, SC (US); Kate Fuller CURREN, Verona, NJ (US)

(72) Inventors: William FULLER, Bluffton, SC (US); Kate Fuller CURREN, Verona, NJ (US)

(21) Appl. No.: 14/312,123

(22) Filed: Jun. 23, 2014

(51) Int. Cl. G06Q 50/00; A01K 29/00

(52) U.S. Cl. CPC G06Q 50/01; A01K 29/00

(57) ABSTRACT

An information processing device is provided. This information processing device may be configured to provide an animal social network such that a guardian may establish connections with one or more animals, such as littermates. The information processing device further provides a social network allowing for robust functionality, which may include alerting or notifying guardians of related animals of adverse medical conditions.

### BACKGROUND

1. Technical Field

The present disclosure relates to a database management system, method and device for establishing connections between familial animals, such as littermates.

2. Related Art

Health-related devices are generally known. In particular, as shown in U.S. Pat. No. 8,655,899, devices have been developed for medical diagnosis based on genetic and non-genetic attributes. As also shown in KR 2012-0037430(A), social media services have been developed to establish connections between people who have a pet, wherein the common interest is the pet (animal).

### SUMMARY

However, conventional social networks where animals are of interest do not generate an animal profile that allows for storing particular information of the animals (e.g., medical information of the pets). Further, the conventional social networks where animals are of interest also do not connect animals and their guardians based upon the familial relationships of the animals.

One or more aspects of the present disclosure provide information processing devices, methods, and programs that receive at least one identifying attribute of an animal and compare the at least one identifying attribute of the animal to at least one identifying attribute of at least one other animal. The devices, methods, and programs determine, based on the comparison, if the at least one animal and the at least one other animal are familially related.

### BRIEF DESCRIPTION OF THE DRAWINGS

Exemplary embodiments will be described with reference to the following drawings.

FIG. 1 shows a system 100 in accordance with an exemplary embodiment of the present disclosure.

FIG. 2 shows a user device 110 of the system 100 of FIG. 1.

FIG. 3 shows a server 120 and database 140 of the system 100 of FIG. 1.

FIG. 4a shows the attributes or characteristics of animal data 141 stored in the database 140 of FIG. 1.

FIG. 4b shows the attributes or characteristics of a guardian account 144 stored in the database 140 of FIG. 1.

FIG. 5 shows a high-level flowchart of a process executed by the system 100 of FIG. 1.

FIG. 6 shows a lower-level flow chart of the populate database Step 1000.

FIG. 7 shows a lower-level flow chart of the find relatives Step 1100.

FIG. 8 shows a lower-level flow chart of the animal social network Step 1200.

FIG. 9 shows a login/register sub-Step 1210 of the animal social network Step 1200.

FIG. 10 shows a guardian account management sub-Step 1220.

FIG. 11 shows a find relatives sub-Step 1230.

FIG. 12 shows a search connections sub-Step 1240.

FIG. 13 shows an establish connections sub-Step 1250.

FIG. 14 shows a social communications sub-Step 1260.

FIG. 15 shows an alert/notification Step 1270.

FIG. 16 shows an exemplary screenshot of the user device 110 during the find relatives sub-Step 1230.

FIG. 17 is another exemplary screenshot of the user device 110.

### DETAILED DESCRIPTION OF EXEMPLARY EMBODIMENTS

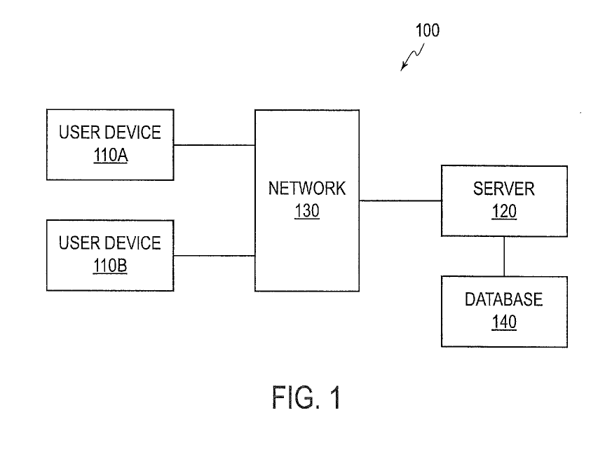

FIG. 1 shows a block diagram of a system 100 according to an exemplary embodiment of the present disclosure. The system 100 may include a user device 110a and one or more other user devices 110b, both communicably coupled via a network 130 with one or more servers 120. The server 120 may in turn be communicably coupled to a database 140. The user device 110 may be, but is not limited to: a mobile device, laptop computer, tablet computer, desktop computer, cellphone, smartphone, personal digital assistant (PDA), smartwatch, wearable computer device, navigational device, carphone, music player device, pager or the like. The network 130 may be, but is not limited to, the Internet, an intranet, a Wide Area Network (WAN), a Local Area Network (LAN) or any other mechanism by which the user device 110 and the server 120 may be communicably connected.

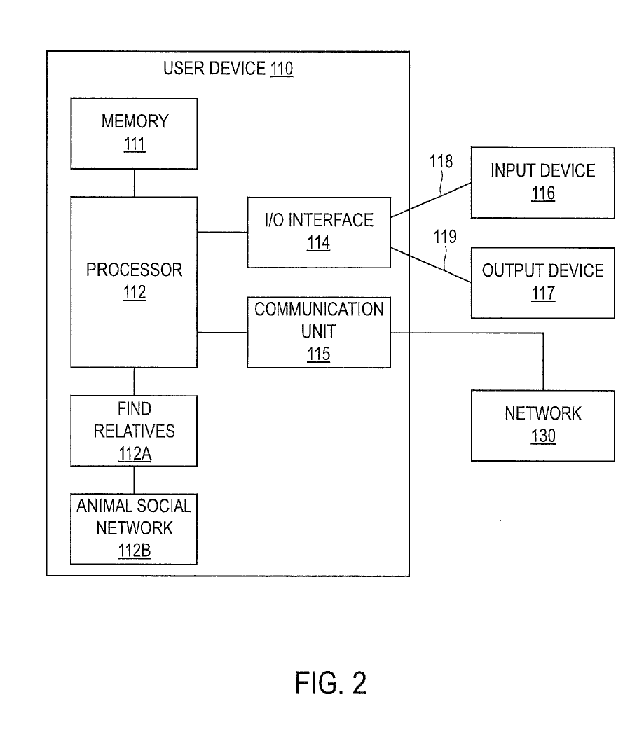

FIG. 2 shows a block diagram illustrating the user device 110 of this exemplary embodiment. The user device 110 may comprise a memory 111 for storing computer executable instructions, and a processor 112 configured to execute the computer executable instructions stored in the memory 111. The memory 111 can be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writeable or rewriteable optical disk and disk drive, a hard drive, flash memory, or the like. Similarly, the non-alterable or fixed memory can be implemented using any one or more of ROM, PROM, EPROM, EEPROM, an optical ROM disk, such as CD-ROM or DVD-ROM disk and disk drive, or the like. The processor 112 can be a CPU, an MPU (optionally including a RAM and/or ROM), or any known or later-developed processor, circuit, or device for executing programs and instructions so as to operate the user device 110.

The user device 110 may further comprise an Input/Output (I/O) interface 114 communicably coupled to an input device 116 and/or an output device 117 via links 118 and 119, respectively. The input device 116 may be one of or any combination of a keyboard, a mouse, a trackball, a touchscreen, a virtual reality glove, a sensor (e.g., biometric sensor), and any known or later-developed device for inputting data and/or control signals to the user device 110. The output device 117 may be one of or any combination of a computer monitor, a cathode ray tube, a liquid crystal display (LCD), a touchscreen display device, an image projector, an electrophoretic display, a virtual reality device, an audio speaker, and any other known or later-developed device for visually displaying or audibly outputting the data output from the user device 110. Each of the various links 118 and 119 can be any known or later-developed device or system for connecting the input device 116 and the output device 117, respectively, to the I/O interface 114. In particular, the links 118 and 119 can each be implemented as one or more of a direct cable connection, a connection over a wide area network, a local area network or a storage area network, a connection over an intranet, a connection over an extranet, a connection over the Internet, a connection over any other distributed processing network or system, and/or an infrared, radio-frequency or other wireless connection.

The user device 110 may further comprise a communication unit 115 (which may comprise a network interface card) that is communicably coupled to the network 130 and that allows the user device 110 to communicate, via the network 130, with another device 101b or the server 120.

The user device 110a may also include a find relatives circuit, routine, or application 113a and an animal profile social network circuit, routine, or application 113b. These disclosed circuits, routines, or applications can be dedicated circuits and/or individual programs and/or routines in a larger program stored in a memory such as the memory 111 and executed by the processor 112. Thus, in exemplary embodiments, the disclosed circuits, routines, or applications can be implemented by one or more programs executed by the processor 112. In certain embodiment, the social network circuit, routine, or application 113b may be a web browser or application stored on the memory 111. These circuits, routines, or applications will be discussed in more detail below.

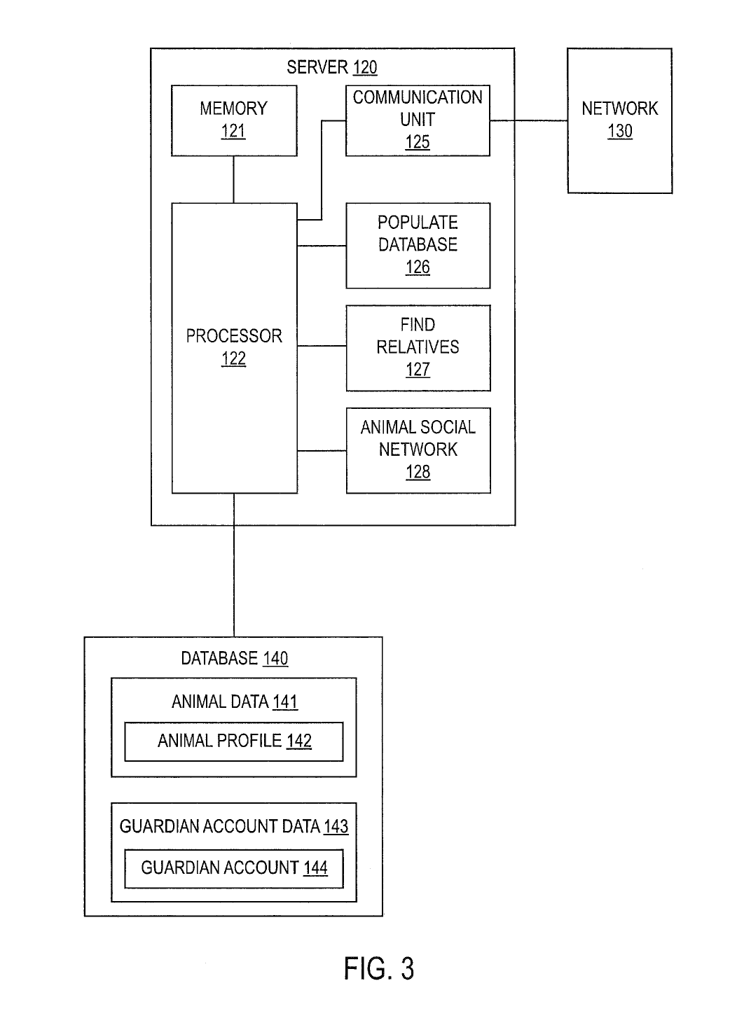

FIG. 3 shows a block diagram of the server 120 and the database 140 of this exemplary embodiment. Similar to the user device 110, the server 120 may comprise a memory 121 for storing computer executable instructions, and a processor 122 configured to execute the computer executable instructions stored in the memory 121. The memory 121 can also be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writeable or rewriteable optical disk and disk drive, a hard drive, flash memory, or the like. Similarly, the non-alterable or fixed memory can be implemented using any one or more of ROM, PROM, EPROM, EEPROM, an optical ROM disk, such as CD-ROM or DVD-ROM disk and disk drive, or the like. The processor 122 can also be a CPU, an MPU (optionally including a RAM and/or ROM), or any known or later-developed processor, circuit, or device for executing programs and instructions so as to operate the server 120.

The server 120 may further comprise a communication unit 125 communicably coupled to the network 130. The communication unit 125 may be communicably coupled to the network 130 to send and receive electronic information to the user device 110a or the user device 110b via the communication unit 115. Any further mention of a user device communicating with the server or another user device may be implemented by the respective communication units of the user device and server as discussed above. For example, when the user of the user device 110a initiates a server request, the communication unit 115 sends, via the network 130, the request to the communication unit 125 of the server 120. In turn, in this example, the communication unit 125 of the server 120 may send, via the network 130, the result to the communication unit 115 of the user device 110. A standard network protocol such as TCP/IP may be implemented by the respective communication units.

The server 120 may also be communicably coupled to the database 140 by wired network, wireless network, or the like. Although the database 140 is shown in FIG. 3 as being separate from the server 120, the database 140 may also be integral with the server 120. Thus, the database 140 may reside on the memory 121, in an external storage (e.g., cloud storage), or any other known or later-developed device for storing electronic information. The database 140 may store animal data 141 (which may comprise full or partial animal profiles 142) and guardian account data 143 (which may comprise full or partial guardian accounts 144). The server 120 can receive animal data 141 and guardian account data 143 from the database 140 and can also send the same data to the database 140 for storage.

The server 120 may also comprise a populate database circuit, routine, or application 126, a find relatives circuit, routine, or application 127, and a social network circuit, routine, or application 128. These disclosed circuits, routines, or applications can also be dedicated circuits and/or individual programs and/or routines in a larger program stored in a memory such as the memory 121 and executed by the processor 122. Thus, in exemplary embodiments, the disclosed circuits, routines, or applications can be implemented by one or more programs executed by the processor 122. The circuits, routines, or applications 126-128 will be discussed in further detail below.

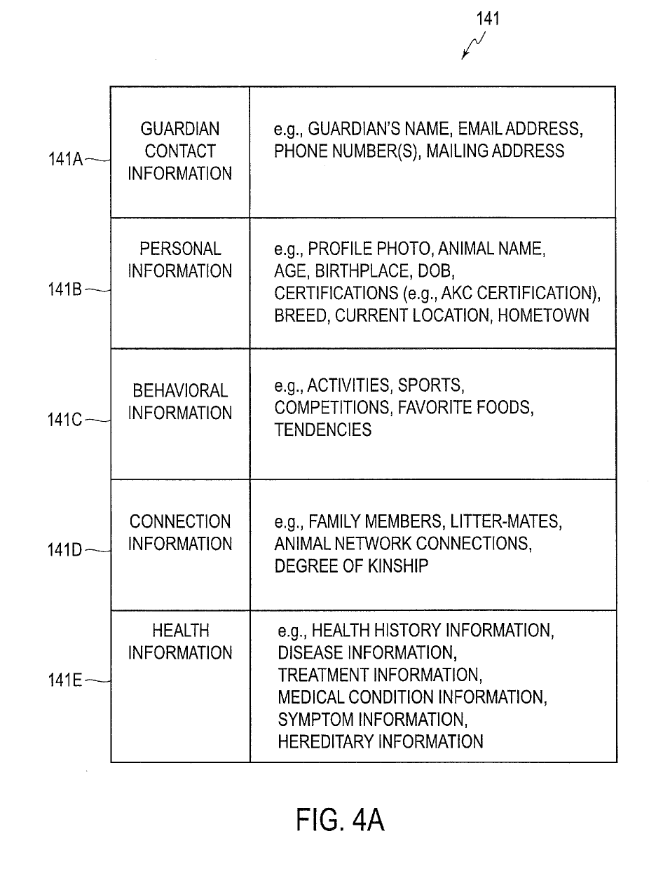

FIG. 4a shows attributes (or characteristics) that may be stored in association with a specific animal as animal data 141 in this embodiment. The animal data 141 may include attributes for a plurality of animals. Examples of attributes or characteristics associated with the animal may comprise: guardian contact information 141a (such as owner or guardian's name, email address, phone number(s), and mailing address); personal information 141b (such as animal name, age, birthplace, date of birth (DOB), certifications (e.g., AKC certification), breed, current location, hometown); behavioral information 141c (such as the animal's favorite activities, sports, competitions, foods and tendencies); connection information 141d (such as the animal's known family members, littermates, and animal social network connections); and health information 141e. The health information may include injuries to the animal as well as genetic maladies that may impact relatives of the animal. For example, the health information may indicate that the associated animal has been diagnosed with glaucoma. If the associated animal is registered in the social network for the animal (described below), the above-described attribute information may be associated with an animal profile.

FIG. 4b shows a diagram of attributes (or characteristics) of a guardian account 144 that may be stored in guardian data 143 in this embodiment. Each guardian account 144 within the animal social network may contain attributes or characteristics associated with the guardian account 144 stored in guardian data 143. Examples of attributes or characteristics associated with a guardian account may comprise: contact information 144a (such as guardian's name, email address, phone number(s), and mailing address); personal information 144b (such as profile photo, age, birthplace, date of birth (DOB), type of guardian (such as breeder, non-breeder pet owner, pet store owner); behavioral information 144c (such as favorite activities, sports, competitions, foods and tendencies); connection information 144d (such as pets, family members, friends, and guardian connections); billing information 144e (such as credit card information, billing address, paypal or any other known or later developed billing data); and credentials 144f (such as user name, password, facial feature information, fingerprints, palm prints, iris information, FACEBOOK or GOOGLE credentials, and remembered device information). In one embodiment, the guardian account 144 may comprise some or all of the same information as the animal profile 142.

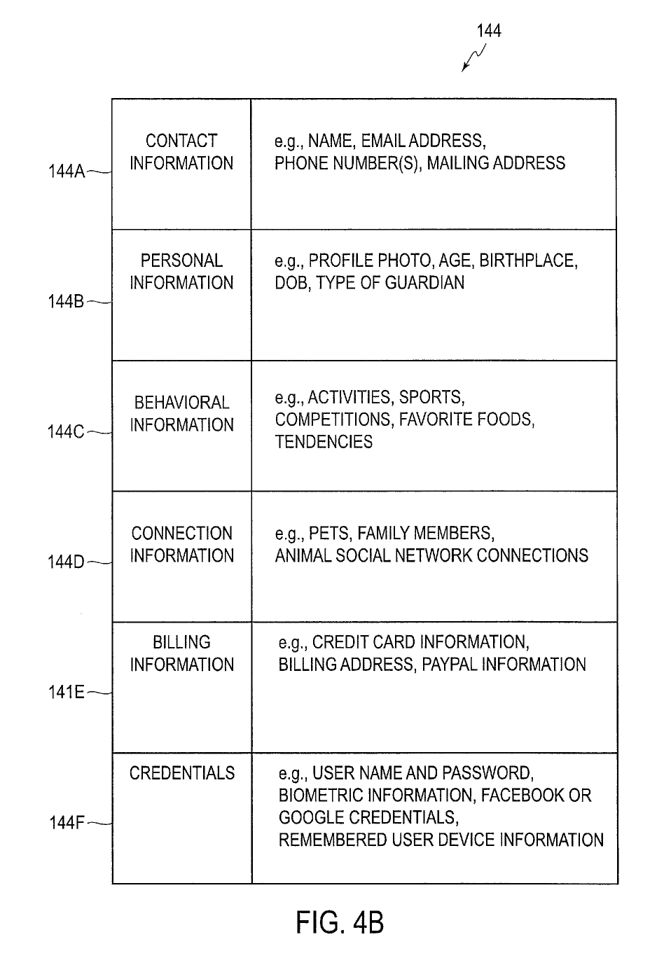

Operation of the above-described system 100 is shown with reference to the following figures. FIG. 5 shows a high-level flowchart of operation of this system. In Step 1000, the populate database circuit, routine, or application 126 of the server 120 operates to populate the database 140 with electronic information. In Step 1100, the find relatives circuit, routine, or application 127 operates to search for and connect animals and their guardians based upon the information populated in Step 1000. In Step 1200, the social network circuit, routine, or application 128 operates to allow the animals and guardians connected in Step 1100 to interact with one another.

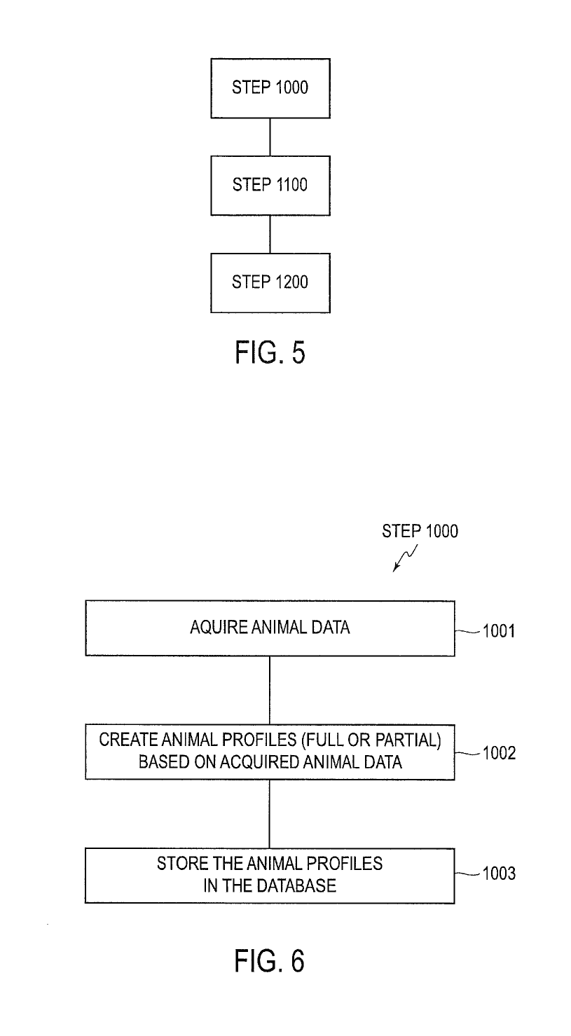

FIG. 6 shows a more detailed flowchart of Step 1000 that may be conducted by the populate database circuit, routine, or application 126. In acquire animal data Step 1001, the server 120 acquires animal data 141. The animal data 141 may be acquired by manual input of a user and/or it may be automatically acquired. If the animal data 141 is manually input, an input device (connected to the server 120 or a separate user device) may be used to input attributes or characteristics comprising the animal data 141. If the animal data is automatically acquired, it may be imported from another data repository such as a commercial database (e.g., the American Kennel Club database, a pet store database, a breeder's database, etc.). In Step 1002, animal profiles 142 (full or partial) may be created based on the acquired animal data 141. In Step 1003, the created animal profiles 142 and any remaining animal data 141 may be stored in database 140.

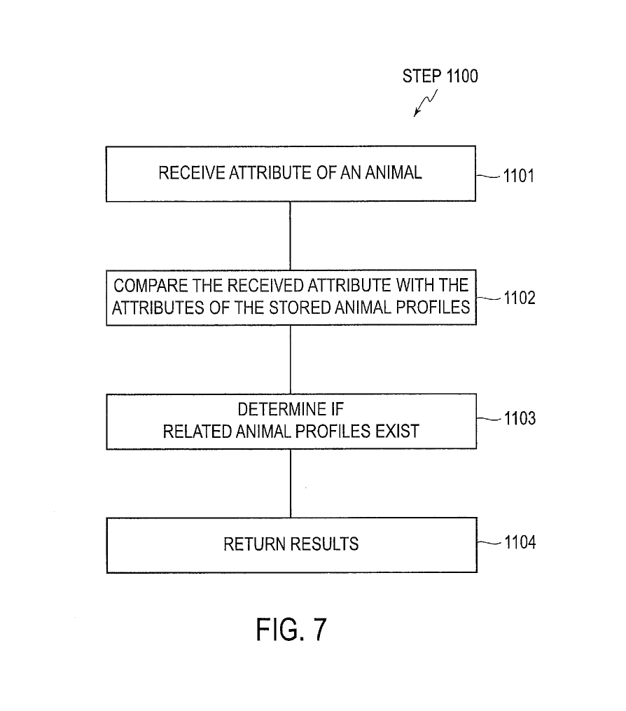

FIG. 7 shows a more detailed flowchart of the operation performed by the find relatives circuit, routine, or application 127, which allows the user of the user device 110a to establish connections based on one or more attributes within the animal data 141. In Step 1101, an attribute of animal data is received by the server 120. For example, the user may initiate the find relatives circuit, routine, or application 113a from the user device 110. This process may prompt the user to enter at least one attribute of animal data 141. In certain aspects in which the find relatives circuit, routine, or application 113a is a web browser or application, the user may enter information into the input device 116 so as to populate fields displayed on the output device 117. The find relatives circuit, routine, or application 113a may send the entered animal data (attribute) to the server 120 via the network 130.

In Step 1102, the received attribute is compared with the attributes within animal data 141 stored on the database 140. In Step 1103, based on the comparison in Step 1102, a determination is made as to whether the received attribute sufficiently matches any attribte within animal data 141 such that the animals are related. For example, if the attributes received in Step 1101 are a DOB, birthplace, breed, and parent family members, and at least one of these attributes matches the same attribute of an animal whose animal data 141 is stored in the database 140, it may be determined that a related animal exists. In some embodiments, the determination of whether a related animal exists may be based on the level of connection between the animals. For example, a familial relationship may be of the type of: littermate, sibling, parent, cousin or the like. For a degree of kinship-type association, the user may set a priority for immediate family (e.g., littermates) over extended family. Thus, only animals from the same litter would be determined to be sufficiently related. In some embodiments, this could be a default setting. The one or more related animal profiles that exist can be returned as results in Step 1104. Otherwise, in the case no related animals are found, a message to the same effect can be sent to the user device 110 in Step 1104.

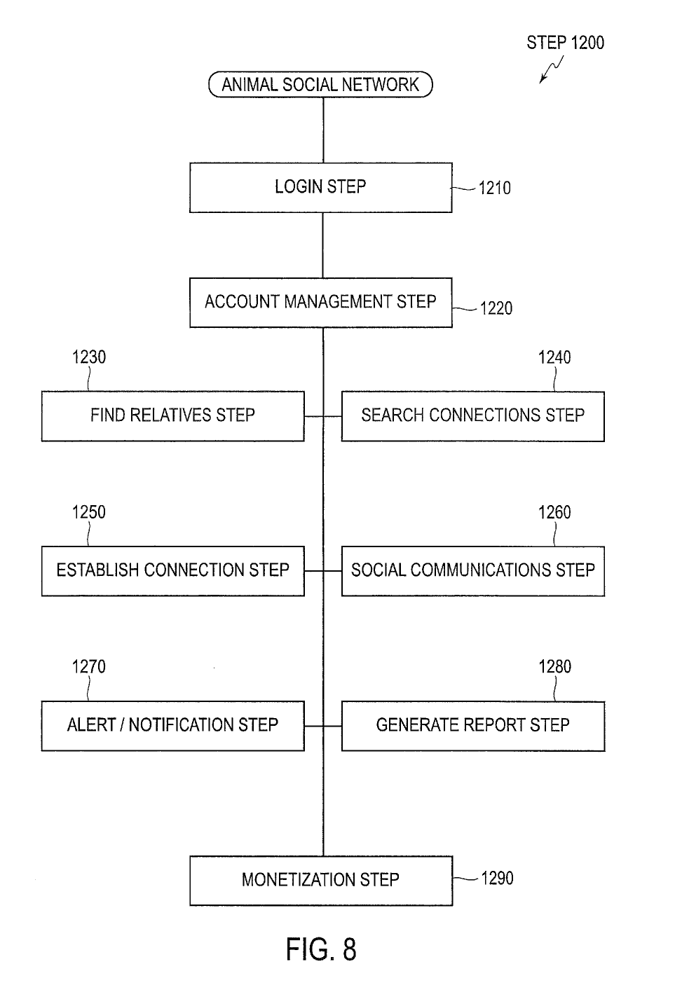

FIG. 8 shows, by way of a more detailed flowchart exemplifying Step 1200 performed by the social network circuit, routine, or application 128, a specific embodiment of the above-described operations. The social network circuit, routine, or application 128 enables users (e.g., guardians) of the user device 110a to interact with and participate in an animal social network. An animal social network is a computer network connecting guardians of animals with other guardians based on relationships of the animals such as kinship. Examples of social networks include FACEBOOK®, GOOGLE+® and LINKEDIN. As shown in FIG. 8, the Step 1200 may include sub-Steps such as: login sub-Step 1210, account management sub-Step 1220, find relatives sub-Step 1230, search connections sub-Step 1240, establish connections sub-Step 1250, social communications sub-Step 1260, an alert/notification sub-Step 1270, generate reports sub-Step 1280, and monetization sub-Step 1290. These sub-Steps are described in greater detail below with reference to FIGS. 8-16.

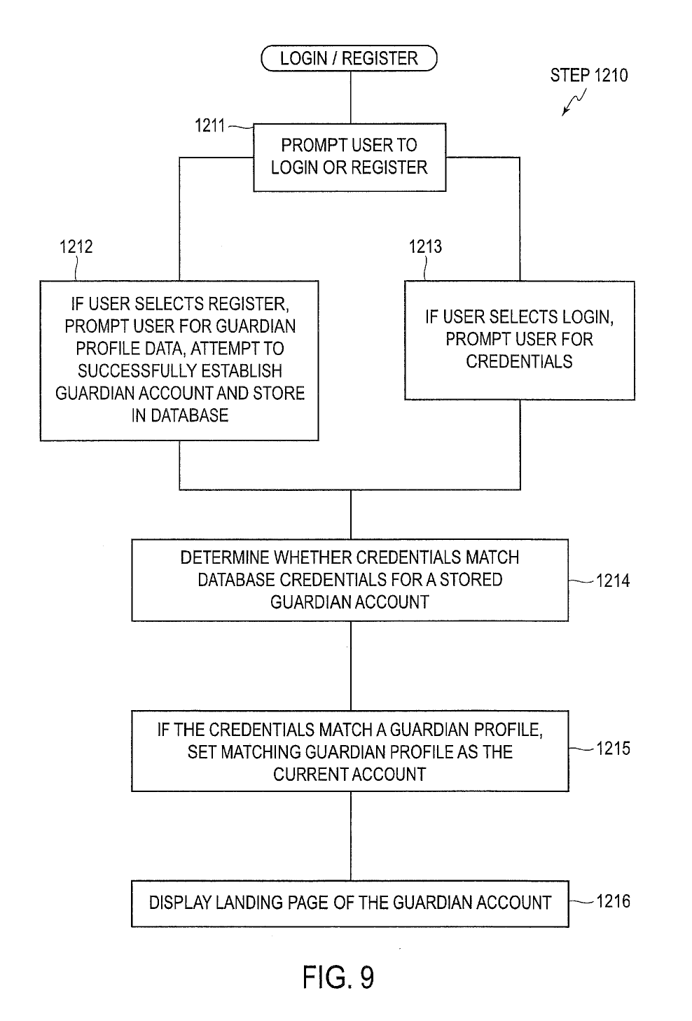

As shown in FIG. 9, the login Step 1210 allows for a user to register and log in to the animal social network. In Step 1211, this process may prompt the user of the user device 110 to select or choose either register or login. Register may allow new users to create a guardian account 144 for access to the animal social network. In Step 1212, to register a new guardian account 144, a user may be required to submit guardian account data 143 including but not limited to a: photo, name, contact address, phone number, occupation, DOB and credentials (e.g., user name and password). Alternatively, a user may register a guardian account 144 using credentials from other established websites providing secure login procedures (e.g., FACEBOOK credentials, GOOGLE credentials) with personal information. When the user has successfully registered a guardian account 144, then the guardian account 144 may be stored in the database 140 as guardian account data 143. In Step 1213, the user device 110 may display a prompt, via the output device 117, requesting the user to enter his or her login credentials. In Step 1213, when the user enters the login credentials, the login credentials are sent to the server 120. In Step 1214, the social network circuit, routine, or application 128 may determine whether the received login credentials match credentials for a guardian account 144 stored in the database 140. In Step 1215, if the login credentials match those of a stored guardian account 144, the stored guardian account 144 is set as the current guardian account. In Step 1215, if the received credentials do not match (e.g., invalid username or password), an error message may be sent to the user device 110 and displayed on the output device 117 that may include one of: prompting the user to re-enter the credentials or denying access, for example, if a threshold number of unsuccessful attempts has been logged. In Step 1016, if a successful login has occurred, the server 120 may send landing page data to the user device 110 that is displayed by the output device 117. In other embodiments, the Step 1200 may include a remember operation such that if the guardian has logged in on the same user device 110 before, the login process automatically remembers the guardian account associated with the user device 110, and the guardian account is set as the current guardian account in Step 1215. A registered and logged in guardian is allowed access to the database 140 containing the animal data 141.

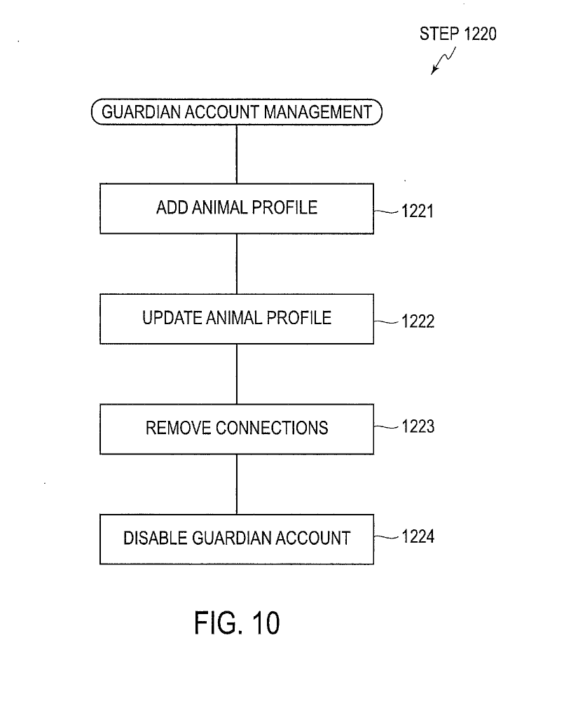

FIG. 10 shows a lower-level flowchart of the Step 1220. The guardian account management Step 1220 allows for account management of registered guardian accounts 144 by respective guardians that are logged in. The guardian account management Step 1220 may comprise: an add animal profile Step 1221, an update animal profile Step 1222, a remove connections Step 1223 and a disable guardian account Step 1224. In add animal profile Step 1221, the user of the guardian account 144 may create and add new animal profiles to his guardian account 144. To do so, a request to create a new animal profile 142 is received by the server 120 from the user device 110. Information to populate the new animal profile 142 may be acquired by manual input and/or may be automatically acquired. For example, when the user clicks/taps on an add animal button displayed on the output device 117, the user is prompted to enter, either automatically or manually, animal data 141 to be used to create the new animal profile 142. If the animal data 141 is manually acquired, the input device 116 of the user device 110 may be used to input attributes or characteristics comprising the animal data 141. If the animal data 141 is automatically acquired, it may be imported from another data repository such as a commercial database (e.g., the American Kennel Club database, a pet store database, a breeder's database, etc.). Thereafter, an animal profile 142 may be generated based on the acquired data and stored in the database 140.

FIG. 10 also shows the update animal profile Step 1222, which allows the guardian to change or update one or more attributes of the animal profile 141 of the currently logged-in guardian account and store the updates/changes in the database 140. The remove connections Step 1223 allows the guardian to remove established connections from the animal profile. The disable guardian account process 1224 may allow the user to temporarily or permanently disable the currently logged-in guardian account 142.

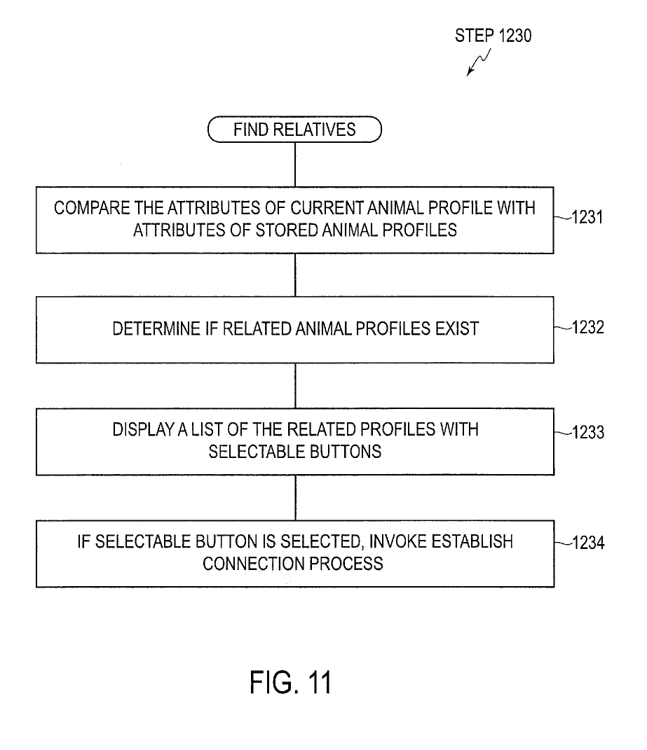

FIG. 11 shows a more detailed flowchart exemplifying the find relatives Step 1230 performed by the social network circuit, routine, or application 128. The find relatives Step 1230 may determine whether familially related animals having profiles 142 exist based on the attributes of the current animal profile 142. In Step 1231, the attributes of the current animal profile 142 are compared with attributes of other registered animal profiles 142 in the database 140. In Step 1232, based on the comparison in Step 1231, a determination is made as to whether the current animal profile's attributes sufficiently match any registered animal profile 142 stored in the database 140. For example, if the attributes are a DOB, birthplace, breed, and parent family members, and at least one of these attributes matches the same attributes of a registered animal profile 142 stored in the database 140, it may be determined that a related animal profile 142 exists. Furthe more, the guardian of the current animal profile 142 may classify and weight the results of the determination by assigning a priority level to the results. In another embodiment, the determination of whether a related profile 142 exists may be based on a level of connection between animals. For example, a familial relationship may be of the type of: littermate, sibling, parent, step-sibling (stepbrother, stepsister) or the like. For a degree of kinship-type association, the user may set a priority for immediate family (e.g., littermates) over extended family. Thus, only profiles 142 of littermates would be determined to be related. In some embodiments, this could be a default setting.

The one or more related animal profiles 142 that exist can be displayed on the output device 117 of the user device 110 as a list of related profiles with selectable buttons in Step 1233. Otherwise, in the case no related animal profile 142 results are found, a message to the same effect can be sent and displayed by the output device 110 in Step 1233. If the list is displayed with selectable buttons in Step 1233, and a selectable button is selected, the establish connection Step 1234 invokes the animal profile establish connection Step 1250 (which is discussed in more detail below).

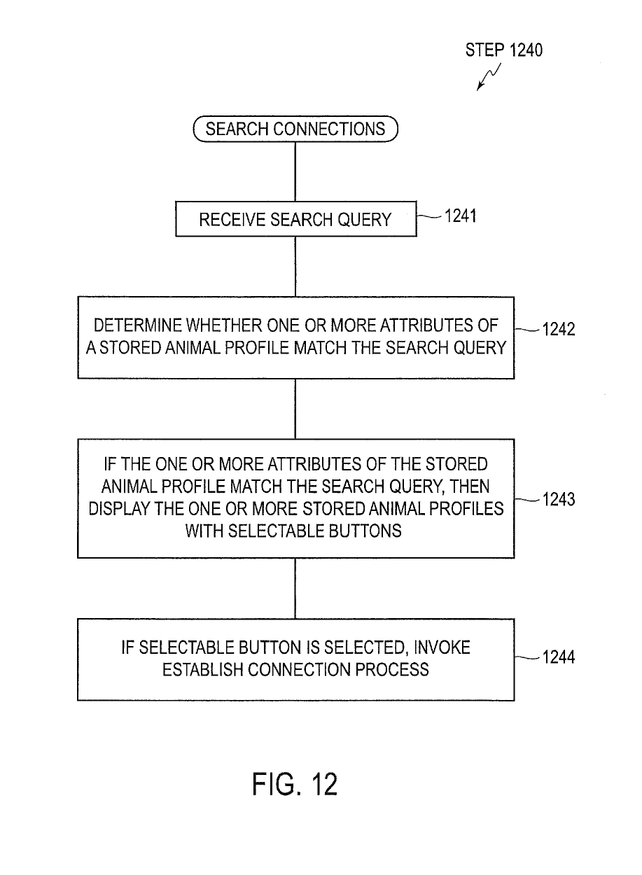

FIG. 12 shows a lower-level flowchart detailing the search connections Step 1240 performed by the social network circuit, routine, or application 128. The search connections Step 1240 allows the user of the guardian account 144 to search for connections of the current animal profile 142 that may not necessarily be related kin. Although Step 1230 discussed above may be implemented, the search connections Step 1240 allows for keyword matching (voice or text) of the animal profiles 142, comparison of images (image recognition) or the like. The Step 1230 may be performed on the related animal profiles 142 determined in the Step 1230. In receive search query Step 1241, the server 120 receives a search query from the user device 110. In Step 1242, it is determined whether one or more attributes of one or more stored animal profiles 142 match the search query. In Step 1243, if the one or more attributes of the stored animal profile 142 match the search query, a listing of the one or more animal profiles 142 that match the search query are sent via the communication unit 125 of the server 120 to the communication unit 115 of the user device 110. The received list of matching one or more animal profiles 142 are displayed by the output device 117 with selectable buttons for each respective animal profile. In Step 1244, if a selectable button of an animal profile 142 is selected/tapped, the establish connection Step 1250 is invoked.

Other embodiments of the search connections Step 1240 are considered. For example, the matching process may determine that an animal profile 142 only matches a user search query when the level of connection is greater than or equal to a predetermined threshold level of connection. In one embodiment, the user device 110 only displays search results of animal profiles 142 that have a level of connection above a predetermined threshold.

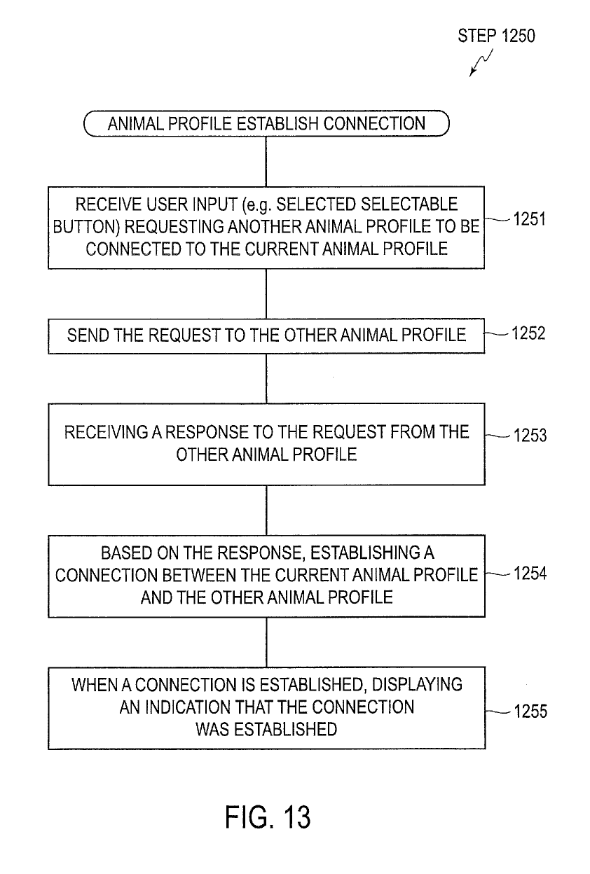

FIG. 13 shows a lower-level flowchart of the animal profile establish connection sub-Step 1250. In Step 1251, user input from the user device 110 is received by the server 120 requesting an other animal profile 142 be connected to the current animal profile 142. In Step 1252, the request for connection is sent from the server 120 to the other animal profile 142 (such that it will be received on the user device of the guardian account). In Step 1253, a response to the request is received by the server 120 from the other animal profile 142. In Step 1254, based on the response, a connection may be established between the current animal profile 142 and the other animal profile 142. For example, if the response is an acceptance of the connection request, a connection is established.

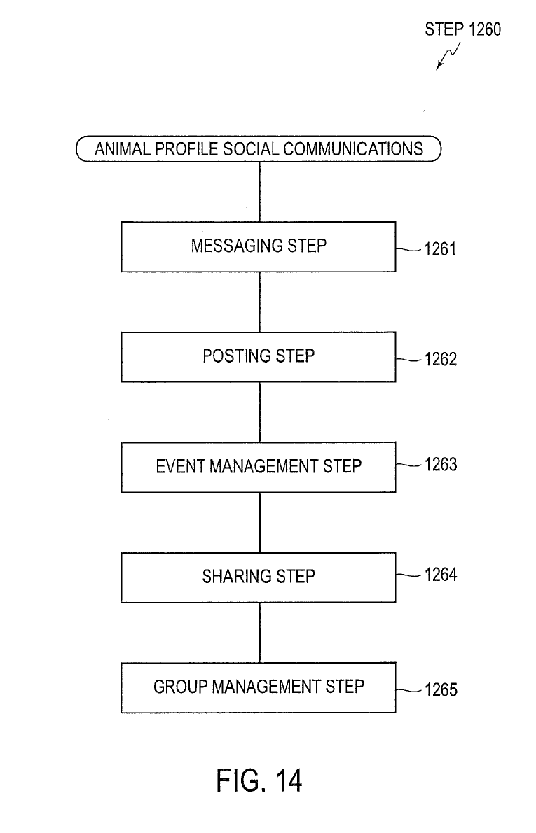

FIG. 14 shows a lower-level flowchart of the animal profile social communications sub-Step 1260. In this Step, the connection between the animal profiles 142 and guardians can allow for further associations and actions, for example: a messaging Step 1261, a posting Step 1262, an event management Step 1263, a sharing Step 1264 (e.g., sharing photos or experiences) and a group management Step 1265. In Step 1261, the user of the current animal profile may compose (a new or reply) message and send the composed message to another guardian in the guardian network. In some embodiments, only guardians with guardian accounts 144 that are connected or have connected animals may be allowed to send a message. In Step 1262, a guardian may manage postings that could be shown on a timeline of the current guardian's account 144. In this regard, information posted to a guardian's timeline may be shown in newsfeeds of other guardian's connected or are following the guardian who is posting. In the same respect, the guardian and other guardians may like, unlike, comment on or ignore the posting. In Step 1263, a guardian may manage events, such as social events. During Step 1263, the user of the current guardian account 144 may create an event, invite others to attend the event, edit the event webpage, and/or send messages (e.g., reminders) to event participants. In Step 1264, a guardian may share text or media (pictures, audio, video) with other guardian accounts or animal profiles 142. In Step 1265, a guardian may manage groups of guardian accounts or animal profiles.

During Step 1265, the guardian may create a new group, appoint administrators of the group, delete a group, invite guardians and/or animal profiles to join the group, remove group members, set access restrictions (i.e., public group, private group) and edit the group page. For example, in one embodiment, a guardian who is a breeder may create a closed social group that invites only littermates and/or other related animals to the group. In some embodiments, the group could be created by the breeder without the need for an invitation process (e.g., the breeder identifies littermates and related animals and populates the group). In this embodiment, the breeder guardian could use the find relatives Step 1230 discussed above to determine littermates and relatives of the littermates.

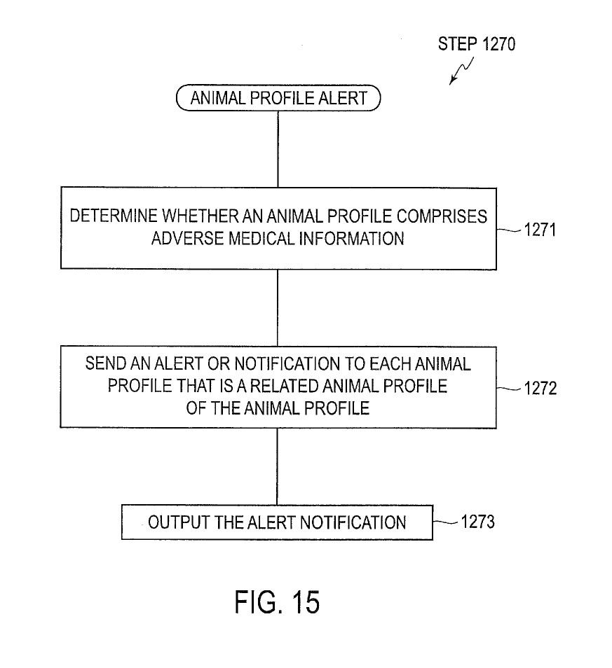

Once animal profiles 142 are connected, an alert/notification Step 1270 may also be executed by the social network circuit, routine, or application 128. FIG. 15 shows a lower-level flowchart illustrating one embodiment of the alert/notification process 1270. The alert/notification Step 1270 may allow for alert handling. In Step 1271, the server 120 may determine whether the health information of at least one animal profile 142 stored in the database 140 includes a disease or hereditary condition. If the result of Step 1271 is positive, the server 120 may send, in Step 1272, a notification or alert to each related animal profile 142. In certain embodiment, sending the notification or alert may comprise sending the notification or alert to a user device 110 associated with the animal profile 142 of the familial connection. In certain embodiments, the notification or alert may only be sent to a user device 110 associated with the animal profile 142 of a littermate. In Step 1273, the alert or notification may be output audibly or visually via the respective output device 117. The alert or notification displayed on the output device 117 may be of any form sufficient to notify a user of the user device 110 of the aforementioned disease or hereditary condition. The notification or alert may comprise at least one of: health history information, disease information, medical condition information, treatment information, hereditary information and symptom information. The treatment information may include at least one of: at least one remedy, at least one drug and at least one veterinarian. This information may be stored on the memory 121 of the server 120 or it may be obtained from another source such as the Internet.

As shown in FIG. 8, a generate report sub-Step 1280 may also be implemented in the animal social network 1200. In Step 1280, the animal social network, circuit, routine, or application 128 may generate reports such as data summaries regarding specific animal profiles. For example, the data summary may be about animals in a specific group, animals connected to the guardian account 144, animals connected to a guardian account 144 that are littermates and/or animals that are specified based on user input. For example, in a group of littermates, Step 1280 could generate data summaries that include traits (e.g., medical traits, behavioral traits) of littermates. In this example, the data summaries may include a frequency of occurrence of the trait, recentness of the reporting of the trait and/or other information regarding the traits of the animals in the group. Furthermore, the data summaries contained in the report may be customizable by the guardian who created the group and/or the appointed administrators of the group. In one embodiment, the reports and/or data summaries may be outputted (e.g., displayed, audibly outputted) to the guardian through the output device 117 or may be reported via email communications to the guardian's email account contained in the guardian account contact information.

As shown in FIG. 8, a monetization sub-Step 1290 may also be implemented within the animal social network 1200. In Step 1290, a charging process may be implemented to charge a user of a guardian account 144 for use of the server 120 and/or database 140. The charge may be based on a periodic subscription (e.g., charged once a month or annually) or may be based on a per-usage basis. The charging process may automatically charge the guardian account 144 based on the billing information 144e included in the guardian account data 143. In one embodiment, the charging process may prompt the guardian to select a payment method, which may be to enter new payment information or to select stored payment information from the billing information 144e. In one embodiment, the charging process may be delayed so as to allow a guardian to enjoy a promotional period to utilize the animal social network. In some embodiments, the charging process may be customizable for each guardian account 144. For example, based on the personal information 144b, including type of guardian, certain types of guardians may be charged at a different charging rate than other types of guardians. In the example, a guardian that is a breeder (type of guardian) may be charged at a higher or lower rate than a guardian that is a non-breeder pet owner (type of guardian). In the per-usage basis charging example, the guardians may be charged for utilization of specific steps of the animal social network. For example, a guardian, who is a breeder, may be charged at a specific charging rate for each report generated or charged. The charging rate for the report generated may be based on a number of factors such as type of animal and/or number of animals contained in the report.

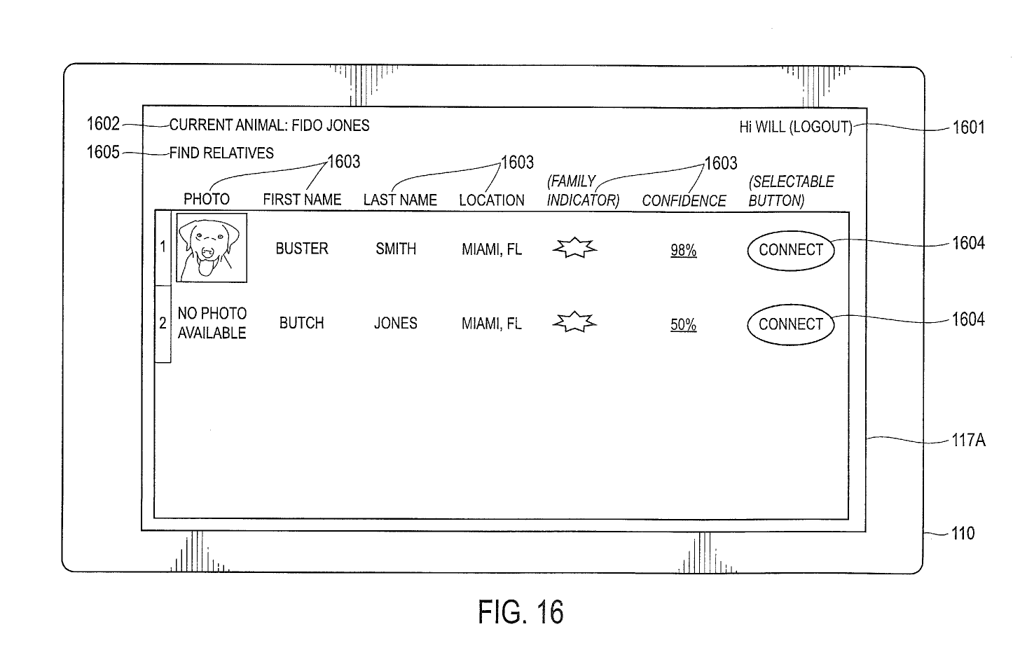

FIG. 16 shows a screenshot of the output device 117 as the user device 110 executes the social network according to one embodiment of the invention. In particular, FIG. 16 shows the user device 110 during the Step 1233 described above. In FIG. 16, the user device 110 is a mobile computer device with a touch screen display device 117a that acts as both the input device 116 and the output device 117. The touch screen display device 117a allows the user to see and touch/tap the selections with a finger or stylus. Item 1601 shows the currently logged in guardian account 144 (e.g., Will) but could comprise other information to indicate the guardian (e.g., a profile picture). Item 1602 is a toggle box that shows the current animal profile 142. The current animal profile 142 may be the animal profile used to perform the social networking steps discussed above. The toggle box 1602 may allow the user to switch between the current animal profile and other animal profile so that the social network processes can be performed for each animal or associated with the guardian account 144. Items 1603 are indicators that may display indications (text or graphics or video) of animal profile information 141. These indicator displays are customizable and may be based on guardian account preferences associated with the guardian account 144 or may be based on animal-specific preferences associated with the animal profile 142. Item 1604 is a selectable button that may be used to invoke the animal profile establish connection Step 1250 discussed above. Item 1605 is a search box that currently shows “Find Relatives” to indicate that a list of related animal profiles is current being displayed, but it may also allow user input to perform the search connections Step 1240.

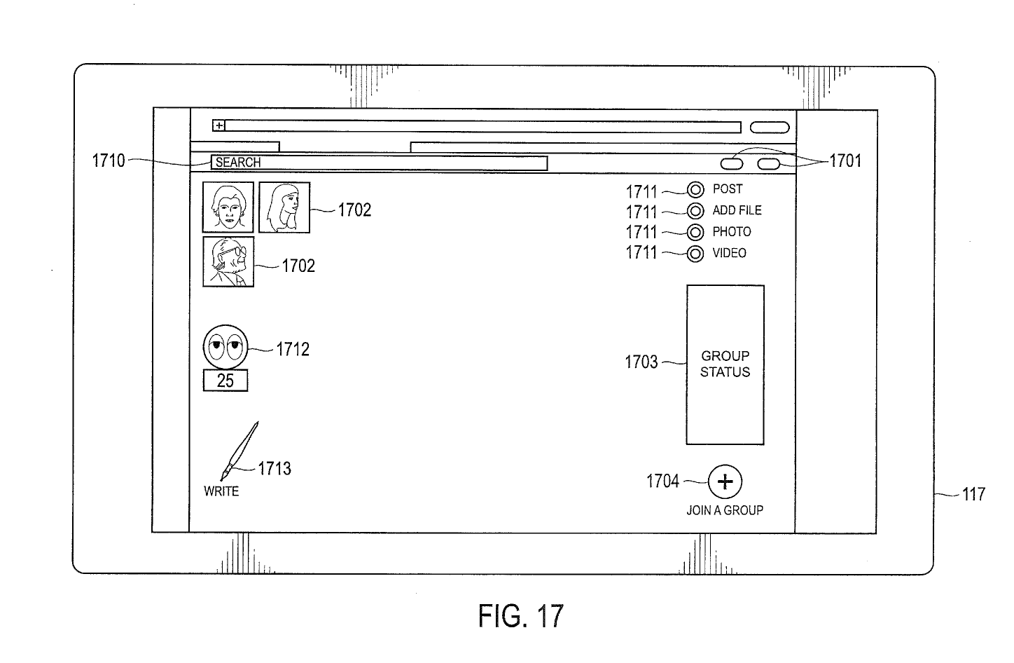

FIG. 17 shows a screenshot of the output device 117 of a group page of animal profiles 142 displayed during the manage groups sub-Step 1260 according to one embodiment of the disclosure. In FIG. 17, the user device 110 may be a personal computer, and the output device 117 may be a monitor linked to the personal computer. Item 1701 shows clickable icons that allow navigational functions for the animal social network process. For example, the navigational buttons may lead a user to: a currently logged in guardian's homepage, a pending connections request screen, a messages screen or an alert/notifications screen. In some embodiments, the navigational buttons may provide balloons or pop-up boxes when clicked on instead of navigating to a new page. Item 1702 shows the profile photos of the group members of the group page. In some embodiments, Item 1702 displays only the group members who have recently interacted with the group. Item 1703 shows the group status. In this embodiment the group is closed, or private, but the group could also be public. Item 1704 is a selectable button allowing the logged in guardian to join other groups from a list of suggested or recommended groups. Item 1710 shows a search box having similarly functionality to search box 1605 discussed above. Items 1711 are selectable buttons that allow for generation of an animal social network post. For example, a post may be text, an image, a video, a question or a file. Item 1712 shows a display icon that indicates the number of registered guardians who have seen the post. In some embodiments, the icon is clickable such that a pop-up display of the list of guardians that has seen the post is displayed. In other embodiments, the list is displayed as a hotspot such that in response to a mouse-over or roll-over technique, the list is displayed. Item 1713, similar to item 1711, allows posting directly on another's posting.

As described above, the information processing device of the present disclosure makes it possible to create and maintain an animal social network, for example, to connect animals and their guardians. With respect to this animal social network, it is possible to create, manage and share information among guardians and their animals.

Further, when there is a possibility that an animal that is related (e.g., a littermate) has an adverse medical condition, the information processing device may notify or alert the guardian of the animal with relevant information. Therefore, it is possible to effectively take preventive measures to protect against the adverse medical condition.

In the foregoing discussion, the present invention has been described with reference to specific exemplary aspects thereof. But the present invention is not confined to the configuration listed in the foregoing embodiments, as it is easily understood that the person skilled in the art can modify such configurations into various other modes without departing from the broader spirit and scope of the invention. Accordingly, the foregoing discussion and the accompanying drawings are to be regarded as merely illustrative of the present invention rather than as limiting its scope in any manner.

What is claimed is:

1. An information processing device, comprising:
a memory; and
a processor coupled to the memory and configured to:
receive at least one identifying attribute of an animal;
compare the at least one identifying attribute of the animal to at least one identifying attribute of at least one other animal; and
determine, based on the comparison, if the at least one animal and the at least one other animal are familially related.

2. The device according to claim 1, wherein the processor is configured to determine if the at least one animal and the at least one other animal are littermates.

3. The device according to claim 1, wherein the processor is further configured to generate an animal profile based on the received at least one identifying attribute.

4. The device according to claim 1, wherein the at least one attribute is at least one of: a birthplace, a date of birth (DOB), a breed, a name of a particular litter, and a familial relation of the at least one animal.

5. The device according to claim 3, wherein
the processor is further configured to register the at least one other animal as a familial connection of the at least one animal profile.

6. The device according to claim 1, wherein the at least one animal and the at least one other animal are canines.

7. The device according to according to claim 1, wherein the processor only determines that the at least one animal and the at least one other animal are familially related when a level of familial connection is greater than or equal to a predetermined threshold level of familial connection.

8. The device according to claim 5, wherein:
the at least one identifying attribute of the at least one other animal includes health information; and
the processor is further configured to:
determine whether the health information comprises adverse health information; and
when the health information is adverse health information, send a notification or alert to the animal profile.

9. The device according to claim 8, wherein the adverse health information is at least one of a disease or hereditary condition.

10. The device according to claim 9, wherein the alert or notification comprises at least one of: disease information, medical condition information, treatment information, hereditary information and symptom information.

11. The device according to claim 10, wherein the treatment information comprises at least one of: a remedy, a drug, and a local veterinarian medicine service provider.

12. A computer-implemented method, comprising:
receiving, by a processor, at least one identifying attribute of an animal;
comparing, by the processor, the at least one identifying attribute of the animal to at least one identifying attribute of at least one other animal; and
determining, by the processor, based on the comparison, if the at least one animal and the at least one other animal are familially related.

13. The method according to claim 12, wherein the determining step determines if the at least one animal and the at least one other animal are littermates.

14. The method according to claim 12, further comprising: generating, by the processor, an animal profile based on the received at least one identifying attribute.

15. The method according to claim 12, wherein the at least one attribute is at least one of:
a birthplace, a date of birth (DOB), a breed, a name of a particular litter, and a familial relation of the at least one animal.

16. The method according to claim 14, further comprising:
registering the at least one other animal as a familial connection of the at least one animal profile.

17. The method according to claim 12, wherein the at least one animal and the at least one other animal are canines.

18. The method according to claim 12, wherein the determination step only determines that the at least one animal and the at least one other animal are familially related when a level of familial connection is greater than or equal to a predetermined threshold level of familial connection.

19. The method according to claim 16, wherein:
the at least one identifying attribute of the at least one other animal includes health information; and
the method further comprises:
determining whether the identifying attribute comprises adverse health information; and
when the health information is adverse health information, sending a notification or alert to the animal profile.

20. The method according to claim 19, wherein the adverse health information is at least one of a disease or hereditary condition.

21. The method according to claim 20, wherein the alert or notification comprises at least one of: disease information, medical condition information, treatment information, hereditary information and symptom information.

22. The method according to claim 21, wherein the treatment information comprises at least one of: a remedy, a drug, and a local veterinarian medicine service provider.

23. A non-transitory computer readable medium storing a program comprising:
instructions for receiving, by a processor, at least one identifying attribute of at least one an animal;
instructions for comparing, by the processor, the at least one identifying attribute of the animal to at least one identifying attribute of at least one other animal; and
instructions for determining, by the processor, based on the comparison, if the at least one animal and the at least one other animal are familially related.

24. The medium according to claim 23, wherein the determining step determines if the at least one animal and the at least one other animal are littermates.

25. The medium according to claim 23, wherein the program further comprises instructions for generating, by the processor, an animal profile based on the received at least one identifying attribute.

26. The medium according to claim 23, wherein the at least one attribute is at least one of: a birthplace, a date of birth (DOB), a breed, a name of a particular litter, and a familial relation of the at least one animal.

27. The medium according to claim 25, further comprising:
instructions for registering the at least one other animal as a familial connection of the at least one animal profile.

28. The medium according to claim 23, wherein the at least one animal and the at least one other animal are canines.

29. The medium according to claim 23, wherein the determining only determines that the at least one animal and the at least one other animal are familially related when a level of familial connection is greater than or equal to a predetermined threshold level of familial connection.

30. The medium according to claim 27, wherein:
the at least one identifying attribute of the at least one other animal includes health information; and
the program further comprises:
instructions for determining whether the identifying attribute comprises adverse health information; and
instructions for when the health information is adverse health information, sending a notification or alert to the animal profile.

31. The medium according to claim 30, wherein the adverse health information is at least one of a disease or hereditary condition.

32. The medium according to claim 31, wherein the alert or notification comprises at least one of: disease information, medical condition information, treatment information, hereditary information and symptom information.

33. The medium according to claim 32, wherein the treatment information comprises at least one of: a remedy, a drug, and a local veterinarian medicine service provider.
